(19) United States
(12) Patent Application Publication
(10) Pub. No.: US 2018/0111458 A1
(43) Pub. Date: Apr. 26, 2018

(54) Convertible soft top roof unit

(71) Applicant: Dimitri Cretikos, Santa Ana, CA (US)

(72) Inventor: Dimitri Cretikos, Santa Ana, CA (US)

(21) Appl. No.: 15/330,644

(22) Filed: Oct. 24, 2016

(51) Int. Cl. B60J 7/08; B60J 7/185; B60J 7/00

(52) U.S. Cl. CPC B60J 7/08; B60J 7/0007; B60J 7/1858

(57) ABSTRACT

The invention includes a Convertible Soft Top Roof Unit, constructed of Tri-Max™ waterproof woven polyester fabric, comprising a Single Opening or Double Opening or other amount of desired openings, that transforms the roof panels into open or closed mode by opening or closing the zippered roll up panel/s without having to remove the entire roof unit.

The present invention relates to a woven polyester fabric named Tri-Max™ used for soft luggage, covers, and other aftermarket accessories in the All Terrain Vehicle industry.

### CROSS-REFERENCE TO RELATED APPLICATIONS

There are no previous applications to reference in this present application.

### STATEMENT AS TO RIGHTS TO INVENTIONS MADE UNDER FEDERALLY SPONSORED RESEARCH AND DEVELOPMENT

Not applicable

### REFERENCE TO A “SEQUENCE LISTING,” A TABLE, OR A COMPUTER PROGRAM LISTING APPENDIX SUBMITTED ON A COMPUTER DISK

Not applicable

### BACKGROUND OF THE INVENTION

Convertible Soft Top Roof Units are commonly used in sport-utility vehicles for recreational purposes. The foldable roof can typically be moved between an open position, and a deployed position. When in the deployed position, the roof will protect the occupants of the vehicle from various weather conditions. However, there are occasions where the weather is pleasant, and it is desired by the occupants of the vehicle to move the soft top roof to an open position such that the vehicle essentially functions without a roof, and the passenger compartment of the vehicle is exposed to the atmosphere. This allows the occupants of the vehicle to enjoy more favorable weather conditions while driving.

An alternative to the convertible soft top is to use a hard top that is bulky and does not provide any open air feel without removing the entire top. If the entire hard top is removed, it then must be stored, which is often difficult because of the size of the top. It is desirable to design a composite top made of soft material. It is also desirable to provide a top that can be opened to provide what is often referred to as an open air feel, where a portion of the top of the roof is moved from a closed position to an open position exposing a portion of the inside vehicle compartment to the outside.

References Cited

U.S. Patent Documents

| | | | | |
|---|---|---|---|---|
| U.S. Pat. No. | Mar. | Jun. | | Improvement in |
| 205,099 | 29, | 18, | | wagon-covers |
| | 1878 | 1878 | | |
| U.S. Pat. No. | Aug. | May | Studebaker | Top construction |
| 1,670,422 | 28, | 22, | Corp | |
| | 1926 | 1928 | | |
| U.S. Pat. No. | Jul. | Mar. | Schumaker | Safety frame and top |
| 2,785,002 | 26, | 12, | Lawrence A | for tractor |
| | 1954 | 1957 | | |
| U.S. Pat. No. | Feb. | Jun. | Heil Co | Tractor cabs |
| 2,795,458 | 26, | 11, | | |
| | 1954 | 1957 | | |
| U.S. Pat. No. | Dec. | Sep. | Allis- | Narrow base |
| 4,049,294 | 22, | 20, | Chalmers | protective frame |
| | 1975 | 1977 | Corporation | |
| U.S. Pat. No. | Jul. | Dec. | Kent James K | Method and apparatus for |
| 4,179,152 | 13, | 18, | Jr | securing fabric tops to |
| | 1977 | 1979 | | a vehicle |
| U.S. Pat. No. | Feb. | Oct. | Hutchinson | Automobile cover |
| 4,475,764 | 23, | 9, | Mark R | |
| | 1983 | 1984 | | |
| U.S. Pat. No. | Sep. | Sep. | Welter | Top carrier for a |
| 4,538,752 | 19, | 3, | Charles J | convertible |
| | 1984 | 1985 | | jeep-type vehicle |
| U.S. Pat. No. | Aug. | Jul. | White | Jeep top fastening means |
| 4,600,235 | 30, | 15, | Automotive | |
| | 1984 | 1986 | Corporation | |
| U.S. Pat. No. | Feb. | Jul. | Bestop, Inc. | Apparatus for detachably |
| 4,757,854 | 26, | 19, | | fastening a stretchable |
| | 1987 | 1988 | | fabric panel to a rigid |
| | | | | frame |
| U.S. Pat. No. | Jun. | Dec. | Caterpillar | Non-Metalic roof for a |
| 5,695,238 | 20, | 9, | Inc. | work machine |
| | 1995 | 1997 | | |
| U.S. Pat. No. | Oct. | Mar. | Bestop, Inc. | Vehicle roof assembly |
| 5,725,273 | 20, | 10, | | with removable and |
| | 1995 | 1998 | | storage cockpit cover |
| U.S. Pat. No. | Dec. | Sep. | Perry-Bores; | Mechanism for |
| 5,803,529 | 17, | 8, | Carol A. | selectively installing |
| | 1996 | 1998 | | and removing a cloth |
| | | | | top from a jeep-type |
| | | | | vehicle and including |
| | | | | a separately removable |
| | | | | forward top portion |

### SUMMARY OF INVENTION

The present invention is directed to a Convertible Soft Top Roof Unit constructed of the waterproof woven polyester fabric named Tri-Max™; with intergraded zippered panels that transforms the roof into a convertible without having to remove the entire roof unit; with front zippered panel/s that roll/s up and is securely packed under the roof on the Single Opening model, and front and rear zippered panels that roll up and are securely packed under the roof on the Double Opening model. Tri-Max™ polyester fabric is UV treated for maximum protection against harmful rays of the sun.

The Convertible Soft Top Roof Unit is perfect for sunset and night rides when there is less sunlight. The Roof Unit is easily secured to most roll cages such as the RZR roll cage using heavy duty quick release buckles and self-fastening webbing. The reverse coil zippers keep the collection of dust and dirt to a minimum.

Further embodiment is the present invention presents a Single Opening model for use on small roll cage all terrain vehicles and watercraft.

Further embodiment is the present invention presents a Double Opening model for use on larger roll cage street vehicles, on all terrain vehicles, and watercraft.

Further embodiment is the present invention in both the Single Opening model and Double Opening model the user can convert the roof unit from a solid roof to a convertible roof by unzipping the roof panel on three sides and rolling the roof panel to the secured side and fastening it into a safe position using the provided hook and loop straps permanently attached to the roof unit.

### DRAWINGS

FIG. 1 is a depiction of Convertible Soft Top Roof Unit with Single Opening from the underside with the roof in a closed position.

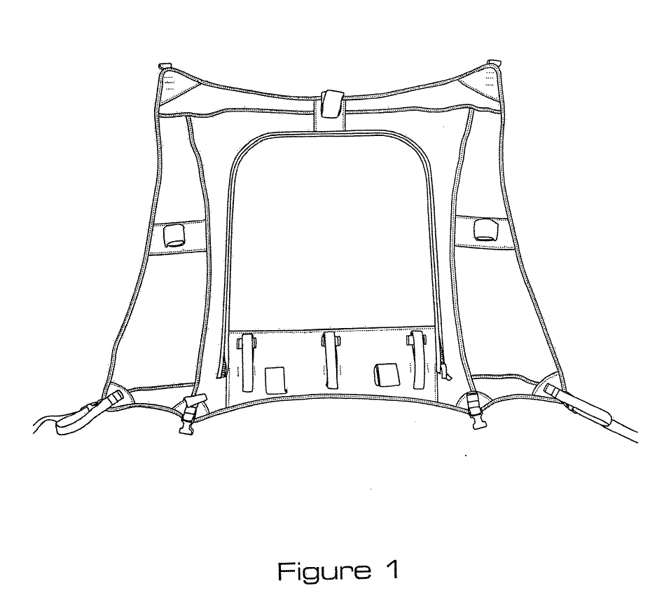

FIG. 2 is a depiction of Convertible Soft Top Roof Unit with Single Opening from the top side with the roof in a closed position.

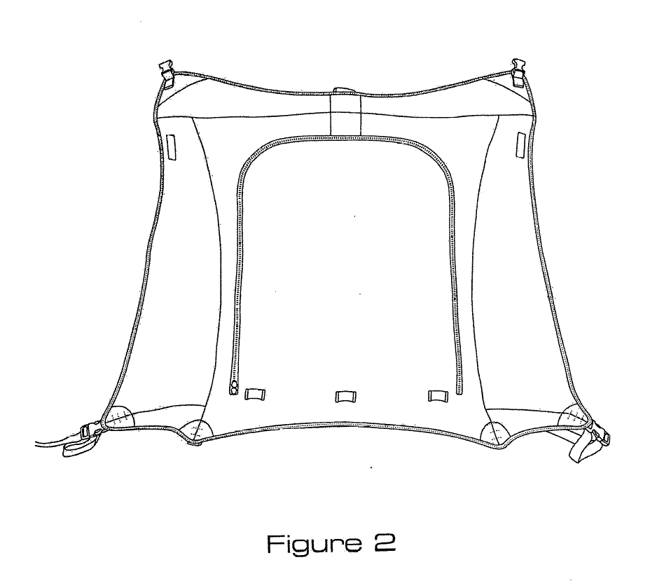

FIG. 3 is a depiction of Convertible Soft Top Roof Unit with Single Opening from the underside with the roof in an open position and secured with hook and loop straps.

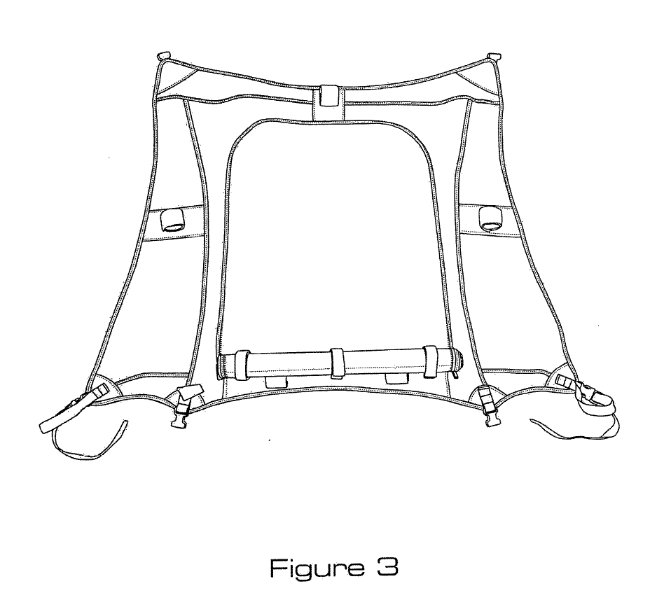

FIG. 4 is a depiction of close up view of Convertible Soft Top Roof Unit with Single Opening displaying the convertible section rolled into the open position and secured with hook and loop straps.

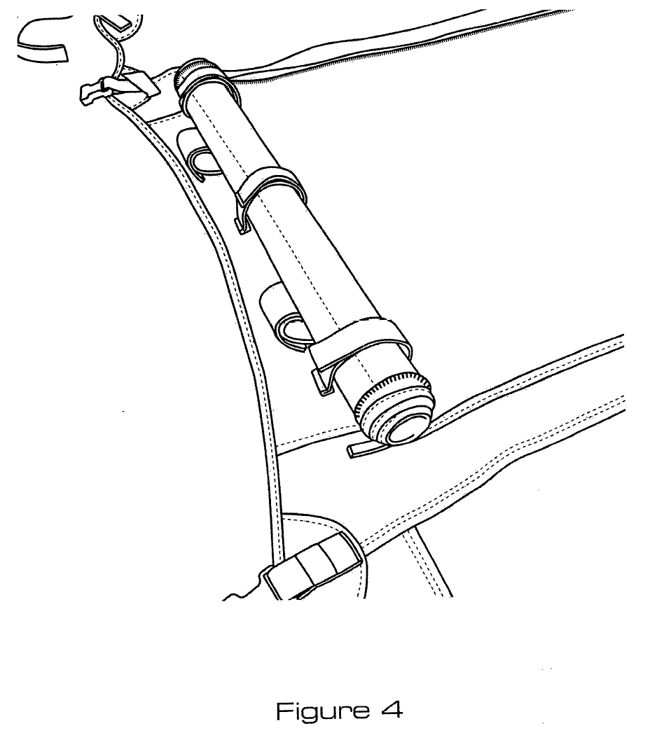

FIG. 5 is a plan view depiction of Convertible Soft Top Roof Unit with Single Opening displaying the convertible section rolled into the open position and secured with hook and loop straps.

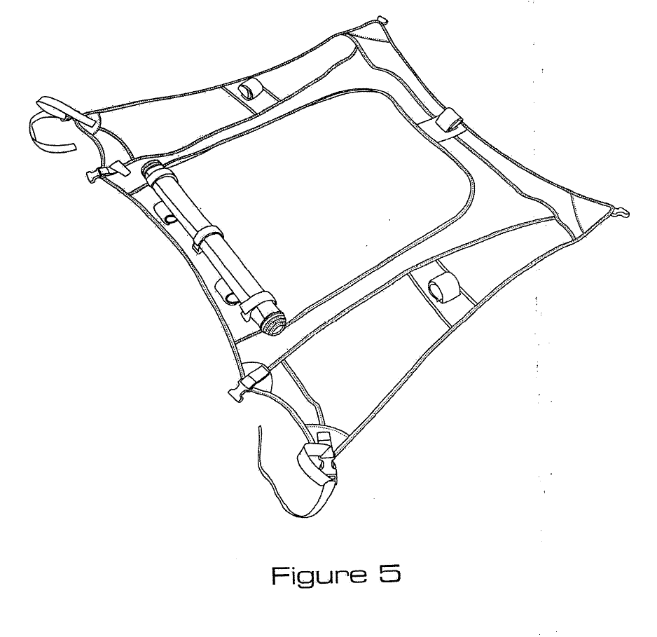

FIG. 6 is a depiction of a close up view of a portion of Convertible Soft Top Roof Unit with Single Opening displaying the hook and loop straps used to secure and fasten into place the roof unit onto the roll cage of a typical transportation apparatus employing any type roll cage.

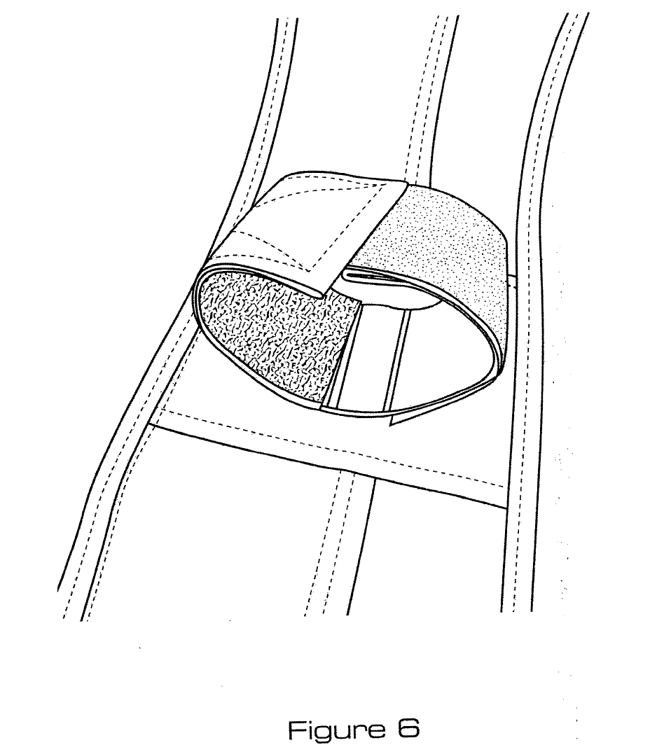

FIG. 7 is a depiction of a close up view of a portion of Convertible Soft Top Roof Unit with Single Opening displaying the closed quick release buckle/s used to fasten the roof unit onto the roll cage of a typical transportation apparatus employing any type roll cage and where flexibility in attachment is desired.

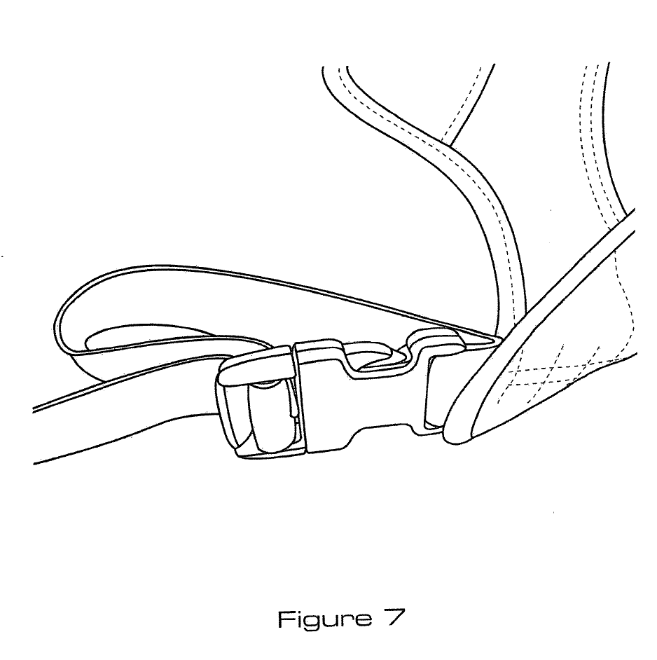

FIG. 8 is a depiction of a close up view of a portion of Convertible Soft Top Roof Unit with Single Opening displaying the open quick release buckle/s used to fasten the roof unit onto the roll cage of a typical transportation apparatus employing any type roll cage and where flexibility in attachment is desired.

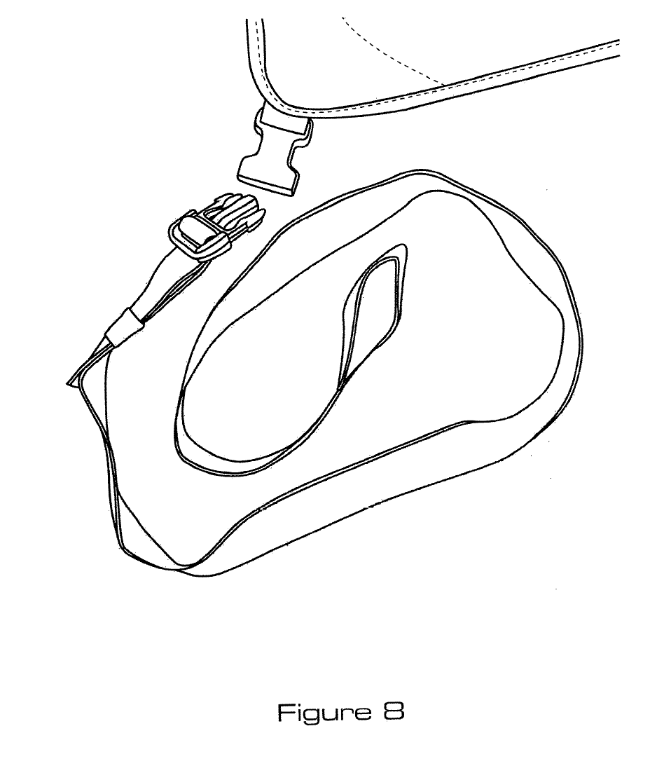

FIG. 9 is a depiction of Convertible Soft Top Roof Unit with Double Opening displaying the flexibility in attachment to the roof unit in use on all roll cages of any typical transportation apparatus in the off-road, dune buggy, jeep or recreational vehicle employing any type of roll cage around the passenger compartment.

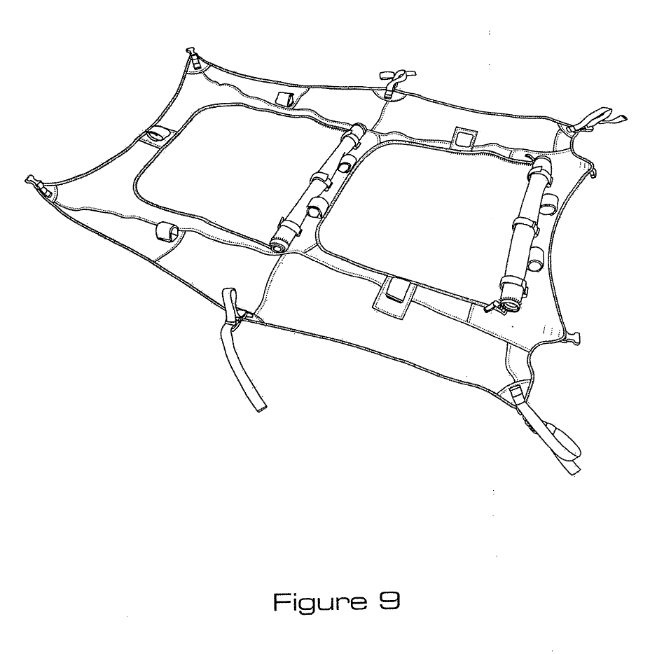

The drawings are an integral part of the system in this invention and by this reference are incorporated herein as though set forth in full.

What is claimed is a Convertible Soft Top Roof Unit comprising:

1. Construction out of the waterproof woven polyester fabric named Tri-Max™; with intergraded zippered panels that transforms the roof into a convertible without having to remove the entire roof unit; with front zippered panel/s that roll/s up and is securely packed under the roof on the Single Opening model, and front and rear zippered panels that roll up and are securely packed under the roof on the Double Opening model. Tri-Max™ polyester fabric is UV treated for maximum protection against harmful rays of the sun.
Convertible Soft Top Roof Unit for Sports Utility Vehicles and other Jeep-type all-terrain and off-road type vehicles having roll bars that surround the passenger compartment. The roof unit comes in two embodiments that include a Single Opening model and a larger Double Opening model designed to fit most transportation apparatus using any type roll cage to surround the passenger compartment.
Also relates to a woven polyester fabric described as Tri-Max™ used for soft luggage, covers, and other aftermarket accessories in the All Terrain Vehicle and transportation apparatus recreation industry.
Any embodiments arising out of the claims set out in this application are by reference made a part of this invention.
1. A further embodiment whereby the roof unit may be manufactured from different types of material.
2. A further embodiment whereby the roof unit may be outfitted with different type fasteners for attachment to the roll cage.
3. A further embodiment whereby the zippered panel/s can be opened and closed using other mechanisms other than zippers.
4. A further embodiment whereby the zippered panel/s may be larger or smaller.
5. A further embodiment whereby the number of zippered panels may lesser or greater than as set forth in the drawings.
6. A further embodiment whereby the roof unit encompasses a single opening or double opening or other number of openings as necessary to be fastened to any configuration of roll cage attached to the passenger compartment any transportation apparatus.
